(19) United States
(12) Patent Application Publication
(10) Pub. No.: US 2025/0189178 A1
(43) Pub. Date: Jun. 12, 2025

(54) ABSORPTION TYPE CHILLER

(71) Applicant: LG Electronics Inc., Seoul (KR)

(72) Inventors: Naehyu PARK, Seoul (KR); Jungwook MOON, Seoul (KR); Taehee KWAK, Seoul (KR)

(21) Appl. No.: 18/976,895

(22) Filed: Dec. 11, 2024

(30) Foreign Application Priority Data
Dec. 11, 2023 (KR) 10-2023-0178544

(51) Int. Cl. F25B 15/00

(52) U.S. Cl. CPC F25B 15/00; F25B 2315/005

(57) ABSTRACT

An absorption type chiller includes an evaporator; an absorber which generates an absorption liquid by mixing the refrigerant evaporated in the evaporator with an absorbent; a regenerator which heats the absorption liquid supplied from the absorber; a condenser to which refrigerant generated in the regenerator is supplied; and a heat pipe which is arranged in at least one of the evaporator and the absorber and elongated. The heat pipe includes a plurality of protrusions which protrude from a surface of the heat pipe and are arranged in a longitudinal direction and a peripheral direction of the heat pipe. A distance between the plurality of protrusions arranged in the peripheral direction of the heat pipe is smaller than a distance between the plurality of protrusions arranged in the longitudinal direction of the heat pipe.

### CROSS-REFERENCE TO RELATED APPLICATIONS

This application claims the benefit of priority of Korean Patent Application No. 10-2023-0178544, filed on Dec. 11, 2023. The disclosure of the prior application is incorporated by reference in its entirety.

### TECHNICAL FIELD

This disclosure relates to an absorption type chiller, and more particularly, to an absorption type chiller equipped with a heat pipe.

### BACKGROUND

A chiller supplies cold water to a cold water demand source, and may cool a cold water by heat exchange between a refrigerant circulating in a refrigerant cycle and a cold water circulating in a demand source. Such a chiller is a large-capacity facility that may be installed in large buildings.

An absorption type chiller is an apparatus that may perform cooling or heating by heat exchange between refrigerant and cold water through a cycle operation using an absorption liquid and the refrigerant.

An absorption type chiller may perform cooling or heating by utilizing the principle that the refrigerant evaporated in an evaporator is absorbed by an absorbent in an absorber, the refrigerant is evaporated as an absorption liquid absorbed the refrigerant passes through a regenerator, and the evaporated refrigerant is condensed as it passes through a condenser.

An absorption type chiller includes a heat pipe used in an absorber and an evaporator. In the evaporator, the refrigerant outside the heat pipe cools the water flowing inside the heat pipe, and in the absorber, an absorbent flows down along the outer surface of the heat pipe and may absorb water particles in the air.

The ‘heat pipe used in an absorption-type chiller/heater’ disclosed in Korea Registered Patent No. 10-1786858 (Publication date: Oct. 18, 2017) includes: a plurality of protrusions formed independently on an outer surface; a first groove formed in a peripheral direction between the plurality of protrusions; a second groove that is formed in a pipe-axis direction between the plurality of protrusions and dug deeper than the first groove; and a third groove that is formed in a pipe-axis direction between the plurality of protrusions and dug with a depth corresponding to a depth of the first groove.

The conventional heat pipe has a problem in that the thickness of the liquid refrigerant flowing along the outer surface of the heat pipe increases as the height difference between the protrusion and the groove increases due to the second and third grooves formed in the pipe-axis direction.

In addition, since the thickness of the liquid refrigerant flowing along the outer surface of the heat pipe increases, the heat transfer performance with a material flowing inside the heat pipe deteriorates.

In addition, the thickness of the liquid refrigerant flowing along the outer surface of the heat pipe increases, thereby reducing the material transfer performance between the absorbent flowing down along the outer surface of the heat pipe and moisture in the air.

In addition, since the shape of the outer surface of the heat pipe becomes complicated due to the protrusions and grooves repeatedly formed on the outer surface of the heat pipe, the viscous absorbent is attached to or stagnated in a gap formed between the groove and the protrusion. This causes a problem that heat transfer and mass transfer are deteriorated due to the poor drainage property of the heat pipe.

### SUMMARY

The disclosure has been made in view of the above problems, and may provide an absorption type chiller having an improved heating and cooling performance.

The disclosure may further provide an absorption type chiller having an improved absorption performance of an absorber.

The disclosure may further provide an absorption type chiller having an improved evaporation performance of an evaporator.

The disclosure may further provide an absorption type chiller having an improved absorption efficiency of an absorbent that absorbs water particles.

The disclosure may further provide an absorption type chiller having a uniform film thickness formed on the outside of a heat pipe.

The disclosure may further provide an absorption type chiller having a thin film thickness formed on the outside of a heat pipe.

The disclosure may further provide an absorption type chiller having an improved flowability and drainage on the outside of a heat pipe.

The disclosure may further provide an absorption type chiller having an improved pressure resistance of a heat pipe.

The disclosure may further provide an absorption type chiller having an improved heat transfer performance of a heat pipe.

The disclosure may further provide an absorption type chiller having an improved material transfer performance of a heat pipe.

The disclosure may further provide an absorption type chiller having an increased heat transfer area of a heat pipe.

The disclosure may further provide an absorption type chiller having reduced manufacturing costs.

The disclosure may further provide an absorption type chiller having an improved maintainability.

In accordance with an aspect of the present disclosure, an absorption type chiller includes: an evaporator which evaporates refrigerant; an absorber which generates an absorption liquid by mixing the refrigerant evaporated in the evaporator with an absorbent; a regenerator which heats the absorption liquid supplied from the absorber; a condenser to which refrigerant generated in the regenerator is supplied; and a heat pipe which is arranged in at least one of the evaporator and the absorber, and elongated, in which the heat pipe includes: a plurality of protrusions which protrude from a surface of the heat pipe and are arranged in a longitudinal direction and a peripheral direction of the heat pipe, in which a distance between the plurality of protrusions arranged in the peripheral direction of the heat pipe is smaller than a distance between the plurality of protrusions arranged in the longitudinal direction of the heat pipe, so that the flowability of the absorbent flowing along the outer surface of the heat pipe in the peripheral direction can be improved.

The heat pipe includes: a first flow path which is formed between a plurality of protrusions spaced apart from each other in the longitudinal direction of the heat pipe, and extended in the peripheral direction of the heat pipe; and a second flow path which is formed between the plurality of protrusions arranged in the peripheral direction of the heat pipe, and extended in the longitudinal direction of the heat pipe, so that the absorbent can flow along the first and second flow paths.

A width of the first flow path formed in the longitudinal direction of the heat pipe is larger than a width of the second flow path formed in the peripheral direction of the heat pipe, so that the absorbent can flow through the first flow path rather than the second flow path.

The first flow path extends in a flow direction of liquid flowing along the surface of the heat pipe.

The plurality of protrusions adjacent in the peripheral direction of the heat pipe are directly connected to each other, so that the outer structure of the heat pipe can be simplified.

The heat pipe includes a base pipe which has a surface on which the plurality of protrusions are formed and has a fluid flowing therein, the plurality of protrusions include a surface protruding from the base pipe, and a first inclined surface which connects one end of the surface in a peripheral direction with the base pipe and has an inclination with respect to a radial direction of the heat pipe, so that the flowability of the absorbent in the peripheral direction of the heat pipe can be improved.

The heat pipe includes a slit formed between the first inclined surfaces of the plurality of adjacent protrusions, so that the spreadability of the absorbent in the longitudinal direction of the heat pipe can be secured.

The plurality of protrusions include a second inclined surface extending obliquely from the surface toward the first flow path, so that the spreadability of the absorbent in the longitudinal direction of the heat pipe can be improved.

A distance between the first inclined surfaces formed in the peripheral direction of the heat pipe is shorter than a distance between the second inclined surfaces formed in the longitudinal direction of the heat pipe.

A thickness of the heat pipe with respect to a width of a plurality of protrusions formed in the peripheral direction of the heat pipe is within a range of 0.9 to 1.5 times.

A distance between the plurality of protrusions arranged in the longitudinal direction of the heat pipe is smaller than a length of the plurality of protrusions extended in the longitudinal direction of the heat pipe.

A length of the plurality of protrusions extended in the longitudinal direction of the heat pipe is larger than a width of the plurality of protrusions extended in the peripheral direction of the heat pipe.

A height of the plurality of protrusions protruding from the surface of the heat pipe is larger than the distance between the plurality of protrusions arranged in the peripheral direction of the heat pipe.

A height of the plurality of protrusions protruding from the surface of the heat pipe is larger than a width of the plurality of protrusions formed in the peripheral direction of the heat pipe.

The heat pipe is arranged in both the evaporator and the absorber, so that the shape of the heat pipe can be standardized.

In addition, in accordance with another aspect of the present disclosure, an absorption type chiller includes: an evaporator which evaporates refrigerant; an absorber which generates an absorption liquid by mixing the refrigerant evaporated in the evaporator with an absorbent; a regenerator which heats the absorption liquid supplied from the absorber; a condenser to which refrigerant generated in the regenerator is supplied; and a heat pipe which is arranged in at least one of the evaporator and the absorber, in which the heat pipe includes: a base pipe which has a fluid flowing therein, and extends in a first direction; a plurality of protrusions which protrude from a surface of the base pipe, and are arranged in the first direction and a second direction orthogonal to the first direction on the surface of the base pipe, and in which a distance between the plurality of protrusions arranged in the second direction is smaller than a distance between the plurality of protrusions arranged in the first direction.

The heat pipe includes: a first flow path which is formed between the plurality of protrusions spaced apart from each other in the first direction, and extends in the second direction; and a second flow path which is formed between the plurality of protrusions arranged in the second direction, and extends in the first direction.

A width of the first flow path is larger than a width of the second flow path.

The first flow path extends in a flow direction of a liquid flowing along a surface of the heat pipe.

A plurality of protrusions adjacent to each other in the second direction are directly connected to each other.

Specific details of other embodiments are included in the detailed description and drawings.

### BRIEF DESCRIPTION OF THE DRAWINGS

The above and other objects, features and advantages of the present disclosure will be more apparent from the following detailed description in conjunction with the accompanying drawings, in which:

FIG. 1 is a conceptual diagram of an absorption type chiller according to an embodiment of the present disclosure;

FIG. 2 is a perspective view of a heat pipe according to an embodiment of the present disclosure;

FIG. 3 is an enlarged view of an outer surface of a heat pipe according to another embodiment of the present disclosure;

FIG. 4 is an enlarged view of an outer surface of a heat pipe according to an embodiment of the present disclosure;

FIG. 5 is an enlarged view of 91 in FIG. 2;

FIGS. 6A and 6B are an experimental result graph showing a thickness of a film according to a residual angle according to embodiments of the present disclosure;

FIG. 7 is an experimental result graph comparing the heat transfer area according to embodiments of the present disclosure;

FIG. 8 is an experimental result graph comparing the overall heat transfer coefficient according to embodiments of the present disclosure;

FIG. 9 is a perspective view of a heat pipe according to another embodiment of the present disclosure;

FIG. 10 is an enlarged view of an inner surface of a heat pipe according to another embodiment of the present disclosure;

FIG. 11 is a diagram showing a longitudinal section of a heat pipe according to another embodiment of the present disclosure; and

FIG. 12 is an enlarged view of a cross section of a heat pipe according to another embodiment of the present disclosure.

### DETAILED DESCRIPTION

Description will now be given in detail according to exemplary embodiments disclosed herein, with reference to the accompanying drawings. For the sake of brief description with reference to the drawings, the same or equivalent components may be denoted by the same reference numbers, and description thereof will not be repeated.

In general, suffixes such as “module” and “unit” may be used to refer to elements or components. Use of such suffixes herein is merely intended to facilitate description of the specification, and the suffixes do not have any special meaning or function.

In the present disclosure, that which is well known to one of ordinary skill in the relevant art has generally been omitted for the sake of brevity. The accompanying drawings are used to assist in easy understanding of various technical features and it should be understood that the embodiments presented herein are not limited by the accompanying drawings. As such, the present disclosure should be construed to extend to any alterations, equivalents and substitutes in addition to those which are particularly set out in the accompanying drawings.

It will be understood that although the terms first, second, etc. may be used herein to describe various elements, these elements should not be limited by these terms. These terms are only used to distinguish one element from another.

It will be understood that when an element is referred to as being “connected with” another element, there may be intervening elements present. In contrast, it will be understood that when an element is referred to as being “directly connected with” another element, there are no intervening elements present.

A singular representation may include a plural representation unless context clearly indicates otherwise.

Direction indications of up (U), down (D), left (Le), right (Ri), front (F), and rear (R) shown in the drawings are only for convenience of explanation, and the technical concept disclosed in this specification is not limited thereto.

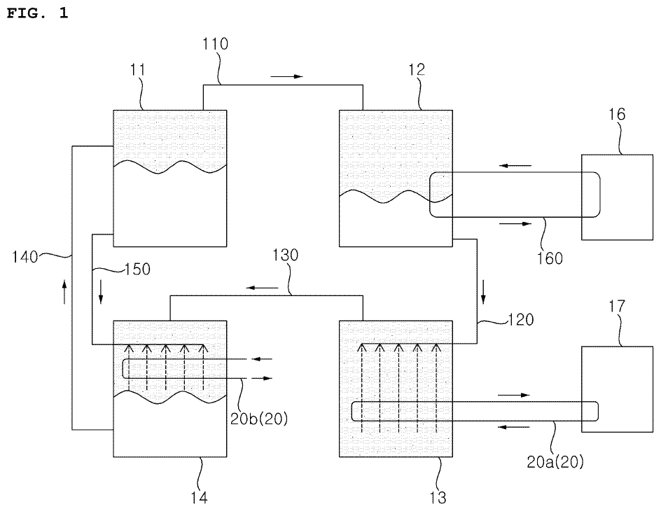

Referring to FIG. 1, the structure and principle of an absorption type chiller 1 are described.

### <<Structure of Absorption Type Chiller 1>>

The absorption type chiller 1 may include a regenerator 11, a condenser 12, an absorber 14, and an evaporator 13. The refrigerant may be heat-exchanged while sequentially circulating through the regenerator 11, the condenser 12, the absorber 14, and the evaporator 13.

### <Regenerator 11>

The absorption type chiller 1 may include a regenerator 11. The regenerator 11 may heat absorption liquid. The absorption liquid may be a solution in which an absorbent and a refrigerant are mixed. The absorption liquid may be referred to as a diluted solution or a weak solution. For example, the absorption liquid may be a lithium bromide aqueous solution.

The absorbent may absorb refrigerant. The absorbent that absorbed the refrigerant may become absorption liquid. When the regenerator 11 heats the absorption liquid, the absorbent and the refrigerant may be separated from each other. For example, the heated refrigerant may be separated from the absorption liquid in a liquid state while changing into a vapor state. The liquid in which the refrigerant is separated from the absorption liquid may be referred to as a strong solution or a thick solution. For example, the absorbent may be lithium bromide, and the refrigerant may be water.

The absorption type chiller 1 may include a first pipe 110 connecting the regenerator 11 and the condenser 12. The refrigerant vapor separated from the absorption liquid may move to the condenser 12 along the first pipe 110. For example, water vapor, which is refrigerant vapor, may move to the condenser 12 through the first pipe 110.

The absorption type chiller 1 may include a fifth pipe 150 connecting the regenerator 11 and the absorber 14. The strong solution from which the refrigerant vapor is separated may be moved to the absorber 14 through the fifth pipe 150. The strong solution moved to the absorber 14 may absorb the refrigerant vapor in the absorber 14.

### <Condenser 12>

The condenser 12 may condense the refrigerant. The regenerator 11 may supply the refrigerant to the condenser 12. For example, the water vapor generated in the regenerator 11 may be supplied to the condenser 12.

The absorption type chiller 1 may include a cooling tower 16 that cools cooling water. A condenser 12 may be connected to the cooling tower 16. The cooling tower 16 and the condenser 12 may be connected through a sixth pipe 160. Cooling water may circulate the cooling tower 16 and the condenser 12 through the sixth pipe 160. The cooling water may absorb heat energy while passing through the condenser 12 and emit heat energy while passing through the cooling tower 16.

Refrigerant vapor supplied to the condenser 12 may be condensed by the cooling water. The cooling water may absorb heat energy from the refrigerant vapor and condense the refrigerant vapor. The refrigerant vapor may change phase into refrigerant liquid in the condenser 12. The refrigerant liquid generated in the condenser 12 may be supplied to the evaporator 13.

The absorption type chiller 1 may include a second pipe 120 connecting the condenser 12 and the evaporator 13. The refrigerant liquid may be supplied to the evaporator 13 through the second pipe 120.

### <Evaporator 13>

The evaporator 13 may be connected to a cooler 17. The cooler 17 may cool an indoor space or supply cold water to the indoor space. In addition, if the flow path is changed, the cooler 17 may heat an indoor space or supply hot water to the indoor space. In this disclosure, for the convenience of explanation, the cooling cooler 17 will be mainly described.

The absorption type chiller 1 may include a first heat pipe 20a arranged in the evaporator 13. The first heat pipe 20a may connect the evaporator 13 and the cooler 17. Water supplied to the room may flow inside the first heat pipe 20a. The temperature of the water flowing inside the first heat pipe 20a may be lowered as it passes through the evaporator 13. The water may also circulate the evaporator 13 and the cooler 17 through the first heat pipe 20a.

The refrigerant liquid supplied to the evaporator 13 may be evaporated. The refrigerant liquid may exchange heat with the water inside the heat pipe 20. The refrigerant liquid may change phase into refrigerant vapor by exchanging heat with the water inside the heat pipe 20. For example, the refrigerant liquid may absorb heat energy from the water inside the heat pipe 20 and be evaporated, and the temperature of the water inside the heat pipe 20 may be lowered by losing heat energy by the refrigerant.

The absorption type chiller 1 may include a third pipe 130 connecting the evaporator 13 and the absorber 14. The refrigerant vapor evaporated in the evaporator 13 may be supplied to the absorber 14 through the third pipe 130.

### <Absorber 14>

The refrigerant evaporated in the evaporator 13 may move to the absorber 14. The strong solution generated in the regenerator 11 may be supplied to the absorber 14 through the fifth pipe 150.

The absorption type chiller 1 may include a second heat pipe 20b arranged in the absorber 14. The second heat pipe may be connected to the cooling tower 16. The cooling water supplied from the cooling tower 16 may flow through the second heat pipe. The cooling water may circulate the cooling tower 16 and the absorber 14 through the second heat pipe.

The strong solution supplied through the fifth pipe 150 may flow down to the second heat pipe 20b. The strong solution may flow downward along the outer surface of the second heat pipe 20b. The refrigerant vapor generated in the evaporator 13 may be supplied to the absorber 14 through the third pipe 130, and the strong solution may absorb the refrigerant vapor. The refrigerant vapor and the strong solution may meet in the absorber 14 and become a diluted solution.

The absorption type chiller 1 may include a fourth pipe 140 connecting the absorber 14 and the regenerator 11. The absorption liquid generated in the absorber 14 may move back to the regenerator 11 through the fourth pipe 140. The absorption liquid supplied to the regenerator 11 may be heated again and separated into the strong solution and the refrigerant vapor.

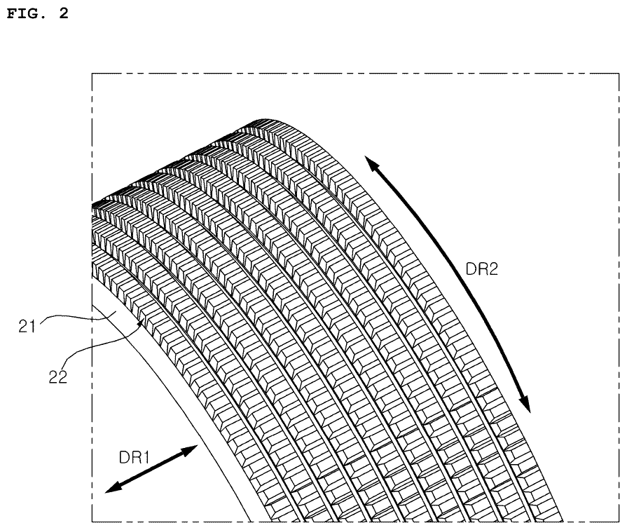

Referring to FIG. 2, the outer shape of the heat pipe 20 is described.

### <Heat Pipe 20>

The heat pipe 20 may be arranged in each of the evaporator 13 and the absorber 14. The shape of the heat pipe 20 arranged in the evaporator 13 may correspond to the shape of the heat pipe 20 arranged in the absorber 14. For example, a single heat pipe 20 may be applied to both the evaporator 13 and the absorber 14.

Water may flow inside the heat pipe 20. Cold water or cooling water may flow inside the heat pipe 20. The heat pipe 20 may include a first heat pipe 20a arranged in the evaporator 13. Cold water may flow inside the first heat pipe 20a. The heat pipe 20 may include a second heat pipe 20b arranged in the absorber 14. Cooling water may flow inside the second heat pipe 20b.

### <Direction Definition—DR1, DR2>

The heat pipe 20 may be elongated. A first direction DR1 may be a direction parallel to the longitudinal direction of the heat pipe 20. The longitudinal direction of the heat pipe 20 may correspond to the pipe axis direction of the heat pipe 20.

A second direction DR2 may refer to the peripheral direction of the heat pipe 20. The second direction DR2 may intersect with the first direction DR1. The peripheral direction may be the same regardless of the cross-sectional shape of the heat pipe 20. For example, if the cross-sectional shape of the heat pipe 20 is circular, the peripheral direction may be a circumferential direction. For example, if the cross-sectional shape of the heat pipe 20 is a tetragon, the peripheral direction may be a circumferential direction of a circle that shares a center with the tetragon.

### <Base Pipe 21>

The heat pipe 20 may include a base pipe 21 forming a frame. The base pipe 21 may include an outer surface and an inner surface. The base pipe 21 may include an internal space 200 in which a fluid flows. The internal space 200 of the base pipe 21 may be surrounded by an inner surface.

### <Protrusion 22>

The heat pipe 20 may include a plurality of protrusions 22 protruding from a surface 224. The plurality of protrusions 22 may protrude from the outer surface 224 of a base pipe 21. The plurality of protrusions 22 may be formed on the outer surface of the base pipe 21. The plurality of protrusions 22 may be arranged in a grid pattern on the outer surface of the base pipe 21. The plurality of protrusions 22 may be adjacent to each other or spaced apart from each other. The plurality of protrusions 22 may be connected to each other.

Through this, the heat transfer area of the heat pipe may be increased.

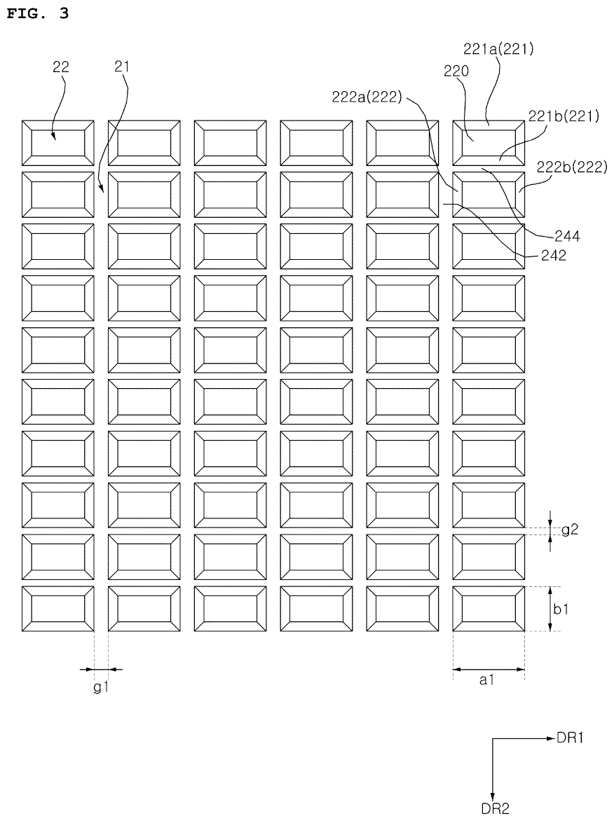

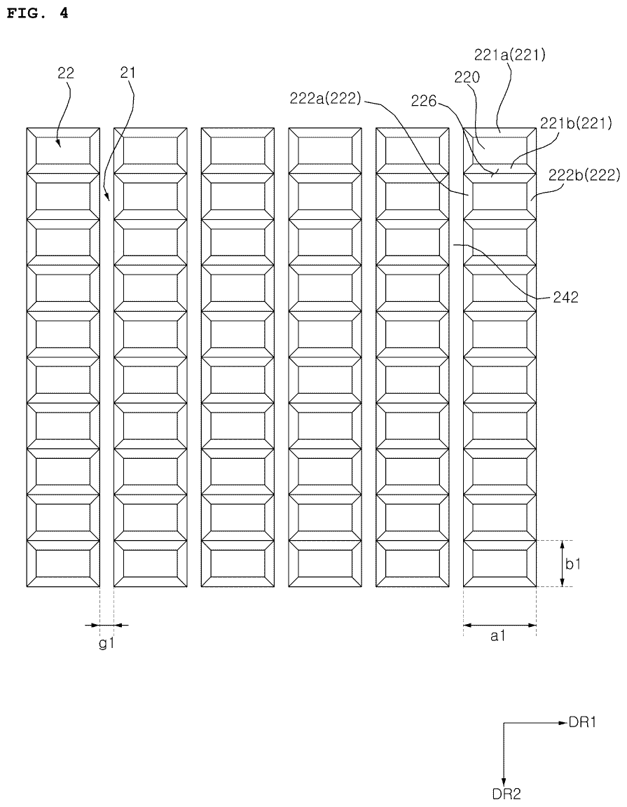

Referring to FIGS. 3 and 4, a structure in which a plurality of protrusions 22 are arranged on the outer surface of the heat pipe 20 is described.

### <Arrangement of a Plurality of Protrusions 22>

The plurality of protrusions 22 may be arranged in the longitudinal direction of the heat pipe 20. The plurality of protrusions 22 may be arranged in the peripheral direction of the heat pipe 20. For example, the plurality of protrusions 22 may be arranged in a grid form, while being spaced apart from each other at a certain interval along the first direction and the second direction.

### <First Flow Path 242>

The heat pipe 20 may include a first flow path 242 extending in the peripheral direction of the heat pipe 20. The first flow path 242 may be formed between a plurality of protrusions 22 spaced apart from each other in the longitudinal direction of the heat pipe 20. That is, the first flow path 242 may be a distance between a plurality of protrusions 22 arranged in the first direction. The first flow path 242 and the plurality of protrusions 22 arranged in the peripheral direction of the heat pipe 20 may be arranged alternately along the longitudinal direction of the heat pipe 20.

The first flow path 242 may include a plurality of first flow paths 242 arranged in the longitudinal direction of the heat pipe 20. The plurality of first flow paths 242 may be spaced apart from each other in the longitudinal direction of the heat pipe 20. A plurality of protrusions 22 may be located between the plurality of first flow paths 242 spaced apart from each other.

The first flow path 242 may extend in the flow direction of the liquid flowing along the surface 220 of the heat pipe 20. The strong solution distributed through the fifth pipe 150 may move in the second direction. The second direction may be parallel to the up-down direction. The strong solution may flow downward along the circumference of the heat pipe 20.

### <Second Flow Path 244>

The heat pipe 20 may include a second flow path 244 extending in the longitudinal direction of the heat pipe 20. The second flow path 244 may be formed between a plurality of protrusions 22 spaced apart from each other in the peripheral direction of the heat pipe 20. That is, the second flow path 244 may be a distance between a plurality of protrusions 22 arranged in the second direction. The second flow path 244 and the plurality of protrusions 22 arranged in the longitudinal direction of the heat pipe 20 may be arranged alternately along the peripheral direction of the heat pipe 20.

The second flow path 244 may include a plurality of second flow paths 244 arranged in the peripheral direction of the heat pipe 20. The plurality of second flow paths 244 may be spaced apart from each other in the peripheral direction of the heat pipe 20. A plurality of protrusions 22 may be located between the plurality of second flow paths 244 spaced apart from each other.

The second flow path 244 may extend in a direction intersecting with the flow direction of the liquid flowing along the surface 220 of the heat pipe 20. The strong solution distributed through the fifth pipe 150 may move in the first direction DR1. The first direction DR1 may intersect with the up-down direction. The strong solution may spread in the longitudinal direction of the heat pipe 20.

### <Relationship Between the First Flow Path 242 and the Second Flow Path 244>

The width of the first flow path 242 may be larger than the width of the second flow path 244. The width of the first flow path 242 may be formed in the longitudinal direction of the heat pipe 20. The width of the second flow path 244 may be formed in the peripheral direction of the heat pipe 20. The width of the second flow path 244 may be smaller than the width of the first flow path 242.

Through this, the flowability of the strong solution flowing down in the peripheral direction along the outer surface of the heat pipe may be improved.

### <Specific Shape of Individual Protrusion 22—Surface, Inclined Surface, Slit>

A plurality of protrusions 22 may include a surface 220 protruding from the base pipe 21. The surface 220 (protruded surface) of the plurality of protrusions 22 may be spaced apart from the surface 224 of the base pipe 21. For example, the surface 220 of the plurality of protrusions 22 may be spaced apart in a radial direction from the surface 224 of the base pipe 21.

The plurality of protrusions 22 may include a first inclined surface 221 extending obliquely in the peripheral direction of the heat pipe 20. The first inclined surface 221 may extend from the surface 220 of the plurality of protrusions 22 toward the base pipe 21.

The first inclined surface 221 may connect one end of the peripheral direction (upper end and lower end of FIG. 3) of the surface 220 and the base pipe 21, and may have an incline with the radial direction of the heat pipe 20. Here, the radial direction of the heat pipe 20 is a direction orthogonal to the axial direction (length direction) of the heat pipe 20.

The first inclined surface 221 may include an upstream-side first inclined surface 221a extending from the surface 220 of the protrusion 22 toward the upstream side (upward direction in FIG. 3) in the peripheral direction of the heat pipe 20. The first inclined surface 221 may include a downstream-side first inclined surface 221b extending from the surface 220 of the protrusion 22 toward the downstream side in the peripheral direction of the heat pipe 20. The upstream-side first inclined surface 221a and the downstream-side first inclined surface 221b may face each other. A second flow path 244 may be formed between the upstream-side first inclined surface 221a and the downstream-side first inclined surface 221b.

The plurality of protrusions 22 may include a second inclined surface 222 extending obliquely in the longitudinal direction of the heat pipe 20. The second inclined surface 222 may extend from the surface 220 of the plurality of protrusions 22 toward the base pipe 21. The second inclined surface 222 may extend from the surface 220 of the plurality of protrusions 22 toward the first flow path 242.

The second inclined surface 222 may include one side second inclined surface 222a extending from the surface 220 of the protrusion 22 toward one side in the longitudinal direction of the heat pipe 20. The second inclined surface 222 may include the other side second inclined surface 222b extending from the surface 220 of the protrusion 22 toward the other side in the longitudinal direction of the heat pipe 20. The one side second inclined surface 222a and the other side second inclined surface 222b may face each other. A first flow path 242 may be formed between the one side second inclined surface 222a and the other side second inclined surface 222b.

The distance between the first inclined surfaces 221 may be shorter than the distance between the second inclined surfaces 222. The distance between the first inclined surfaces 221 may be formed in the peripheral direction of the heat pipe 20. The distance between the second inclined surfaces 222 may be formed in the longitudinal direction of the heat pipe 20.

The plurality of protrusions 22 may include a slit 226 formed between the first inclined surfaces 221. The slit 226 may be located between the upstream first inclined surface 221a and the downstream first inclined surface 221b.

<Arrangement Interval of a Plurality of Protrusions 22—Longitudinal Direction and Peripheral Direction, g1>g2>

The interval between a plurality of protrusions 22 arranged in the peripheral direction of the heat pipe 20 may be smaller than the interval between the plurality of protrusions 22 arranged in the longitudinal direction of the heat pipe 20. A second flow path 244 may be formed between the plurality of protrusions 22 arranged in the peripheral direction of the heat pipe 20. A first flow path 242 may be formed between the plurality of protrusions 22 arranged in the longitudinal direction of the heat pipe 20. For example, the interval g2 between the plurality of protrusions 22 arranged in the peripheral direction of the heat pipe 20 may be about 0.1 mm or less. For example, the interval g1 between the plurality of protrusions 22 arranged in the longitudinal direction of the heat pipe 20 may be in the range of about 0.2 mm to 0.4 mm.

### <Relationship of Width and Length of Individual Protrusion 22>

The protrusion 22 may be extended in the longitudinal direction of the heat pipe 20. The protrusions 22 may be extended in the peripheral direction of the heat pipe 20. The length of the protrusions 22 may be formed in the longitudinal direction of the heat pipe 20. The width of the protrusions 22 may be formed in the peripheral direction of the heat pipe 20. The protrusions 22 may be formed in a tetragon shape.

<a1>b1>

The length of the plurality of protrusions 22 extended in the longitudinal direction of the heat pipe 20 may be larger than the width of the plurality of protrusions 22 extended in the peripheral direction of the heat pipe 20. For example, the protrusion 22 may be formed in a rectangular shape in which one side is longer than the other side. For example, the length of the protrusion 22 may be formed to be about 0.45 mm or less. For example, the width of the protrusion 22 may be formed to be about 0.35 mm or less. However, the present disclosure is not limited thereto, and the protrusion 22 may be formed in various shapes such as a triangle, a square, and a circle.

<a1>g1>

The distance between the plurality of protrusions 22 arranged in the longitudinal direction of the heat pipe 20 may be smaller than the length of the plurality of protrusions 22 extending in the longitudinal direction of the heat pipe 20. The width of the first flow path 242 may be smaller than the length of the protrusion 22. For example, the width of the first flow path 242 may be in the range of about 0.15 mm to 0.45 mm.

<b1>g2>

The distance between the plurality of protrusions 22 arranged in the peripheral direction of the heat pipe 20 may be smaller than the width of the plurality of protrusions 22 extending in the peripheral direction of the heat pipe 20. The width of the second flow path 244 may be smaller than the width of the protrusions 22. For example, the width of the second flow path 244 may be formed to be about 0.15 mm or less.

### <Arrangement Distance of the Plurality of Protrusions 22—Direct Connection>

The plurality of protrusions 22 arranged in the peripheral direction of the heat pipe 20 may be connected to each other. That is, the plurality of protrusions 22 arranged in the peripheral direction of the heat pipe 20 may not be spaced apart from each other. For example, the distance between the plurality of protrusions 22 arranged in the peripheral direction of the heat pipe 20 may be 0. The width of the second flow path 244 may be 0.

Through this, the shape of the outer shape of the heat pipe may be simplified.

In addition, the drainage and flow of the heat pipe may be improved.

In addition, the thickness of the liquid flowing along the outer surface of the heat pipe, i.e. the thickness of the film, may be thinned.

In addition, the thickness of the film may be made uniform.

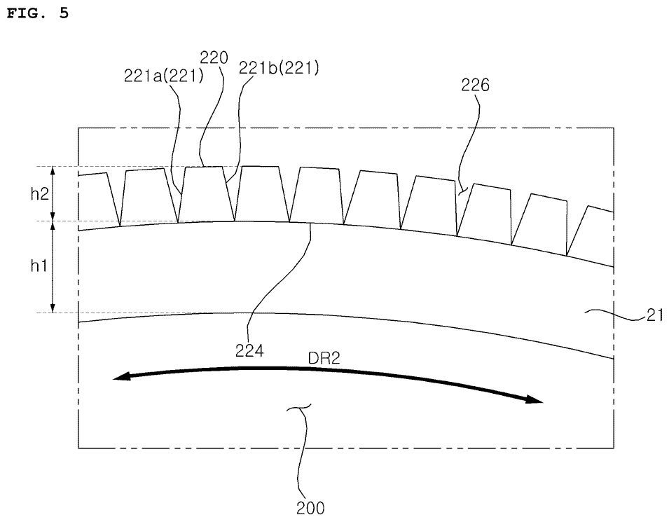

Referring to FIG. 5, the structure of the cross-section of the heat pipe 20 is described.

<h1>h2>

The thickness of the heat pipe 20 may be larger than the height at which the plurality of protrusions 22 protrude. The thickness of the heat pipe 20 may be the thickness of the base pipe 21. The thickness of the heat pipe 20 may be the thickness of the pipe excluding the plurality of protrusions 22. For example, the thickness h1 of the heat pipe 20 may be in the range of about 0.28 mm to 0.45 mm. For example, the height h2 at which the plurality of protrusions 22 protrude may be formed to be about 0.28 mm or more.

This can improve the pressure resistance performance of the heat pipe.

<h1>g2>

The height at which the plurality of protrusions 22 protrude may be larger than the distance between the plurality of protrusions 22 arranged in the peripheral direction of the heat pipe 20. For example, the plurality of protrusions 22 protrude by about 0.28 mm or more, and the distance g2 between the plurality of protrusions 22 arranged in the peripheral direction of the heat pipe 20 may be formed to be about 0.12 mm or less.

<h1>b1>

The height at which the plurality of protrusions 22 protrude may be larger than the width of the plurality of protrusions 22 extended in the peripheral direction of the heat pipe 20. For example, the plurality of protrusions 22 protrude by about 0.28 mm or more, and the width b1 of the plurality of protrusions 22 extended in the peripheral direction of the heat pipe 20 may be formed to be about 0.32 mm or less.

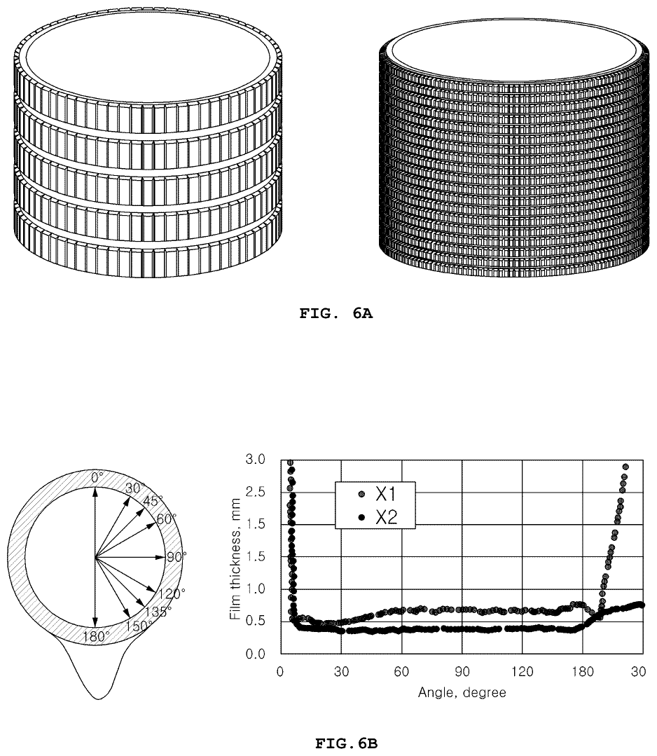

Referring to FIGS. 6A and 6B, the thickness of the film formed according to embodiments of the present disclosure will be described.

Referring to FIG. 6A, the embodiments according to the present disclosure will be described.

### <Comparison of X1 and X2—Number of Protrusions, Size, Distance, Size Compared to the Thickness of the Heat Pipe 20>

The left embodiment of FIG. 6A may be referred to as X1. The right embodiment of FIG. 6B may be referred to as X2. The size of the protrusion 22 in X2 may be smaller than the size of the protrusion 22 in X1. For example, the length of the protrusion 22 in X2 may be shorter than the length of the protrusion 22 in X1. For example, the width of the protrusion 22 in X2 may be shorter than the width of the protrusion 22 in X1. The number of a plurality of protrusions 22 in X2 may be larger than the number of a plurality of protrusions 22 in X1. The width of the first flow path 242 in X2 may be narrower than the width of the first flow path 242 in X1. The number of the first flow path 242 in X2 may be larger than the number of the first flow path 242 in X1. The width of the second flow path 244 in X1 and X2 may be 0. The protrusion height of the protrusion 22 in X2 may be lower than the protrusion height of the protrusion 22 in X1.

The thickness of the heat pipe 20 with respect to the width of the plurality of protrusions 22 in X1 may be in the range of about 0.2 to 0.8 times. The width of the plurality of protrusions 22 may be formed in the peripheral direction of the heat pipe 20. For example, the thickness of the heat pipe 20 with respect to the width of the plurality of protrusions 22 in X1 may be in the range of about 0.4 to 0.65 times.

The thickness of the heat pipe 20 with respect to the width of the plurality of protrusions 22 in X2 may be in the range of about 0.8 to 1.6 times. The width of the plurality of protrusions 22 may be formed in the peripheral direction of the heat pipe 20. For example, the thickness of the heat pipe 20 with respect to the width of the protrusions 22 in X2 may be in the range of about 0.95 to 1.45 times.

### <Residual Angle>

FIG. 6B is a graph showing a thickness of a film according to a residual angle, based on a cross-section of the heat pipe 20.

The strong solution or absorbent supplied to the absorber 14 may move from the upper end to the lower end of the heat pipe 20. The absorbent distributed at the upper end of the heat pipe 20 having a circular cross-section may flow in the peripheral direction along the outer surface of the heat pipe 20 and move to the lower end of the heat pipe 20. At this time, if the residual angle of the upper end located at the uppermost side of the heat pipe 20 is 0 degree, the residual angle of the lower end located at the lowermost side of the heat pipe 20 may be 180 degrees. When the absorbent flows down in the peripheral direction along the outer surface of the heat pipe 20, the residual angle may gradually increase from 0 degree to 180 degrees.

As the film formed on the outer surface of the heat pipe 20 becomes thinner, the heat transfer performance of the heat pipe 20 becomes better. As the thickness of the film formed on the outer surface of the heat pipe 20 becomes uniform, the heat transfer performance of the heat pipe 20 becomes better.

X1 is explained according to the experimental result graph. The film thickness formed on the outer surface of the heat pipe 20 may be the highest at a residual angle near 0 degree and 180 degrees. The film thickness may be formed the thinnest in the residual angle section between 0 degree and 30 degrees. The film thickness may gradually increase in the residual angle section between 30 degrees and 60 degrees. That is, as the absorbent flows down, it may stagnate on the outer surface of the heat pipe 20, and the film thickness may become thicker.

X2 is explained according to the experimental result graph. The film thickness formed on the outer surface of the heat pipe 20 may be the highest at a residual angle near 0 degree and 180 degrees. The film thickness may be uniformly formed in a residual angle section between 0 degree and 150 degrees.

The film thickness formed in X2 may be thinner overall than the film thickness formed at X1. In addition, the film thickness formed in X2 may be more uniform than the film thickness formed in X1.

Accordingly, the heat transfer performance of the heat pipe may be improved.

In addition, the mass transfer performance and heat transfer performance in the absorber may be improved, so that the absorption efficiency may be improved.

In addition, the heat transfer performance in the evaporator may be improved, so that the evaporation efficiency may be improved.

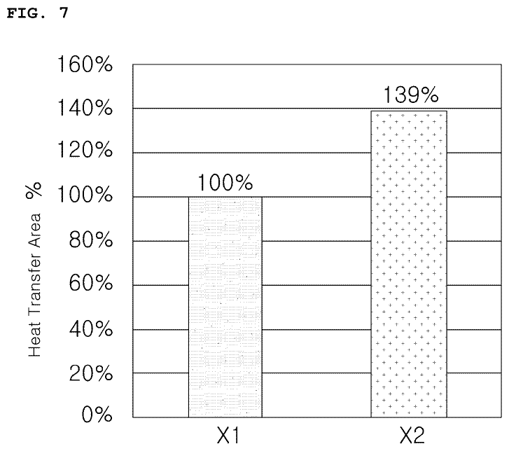

Referring to FIG. 7, the heat transfer area according to the embodiments of the present disclosure will be described.

According to the experimental result graph, the heat transfer area in X2 may be increased more than the heat transfer area in X1. For example, the heat transfer area in X2 may be increased by about 1.4 times more than the heat transfer area in X1. That is, the heat transfer area may be increased as the number of plurality of protrusions 22 increases. In addition, the heat transfer area may be increased as the size of the plurality of protrusions 22 decreases. In addition, the heat transfer area may be increased as the ratio of the width of the protrusions 22 to the thickness of the heat pipe 20 decreases.

Accordingly, the heat transfer performance of the heat pipe 20 may be improved.

In addition, the heat transfer performance may be improved, so that the evaporation efficiency in the evaporator 13 may be improved.

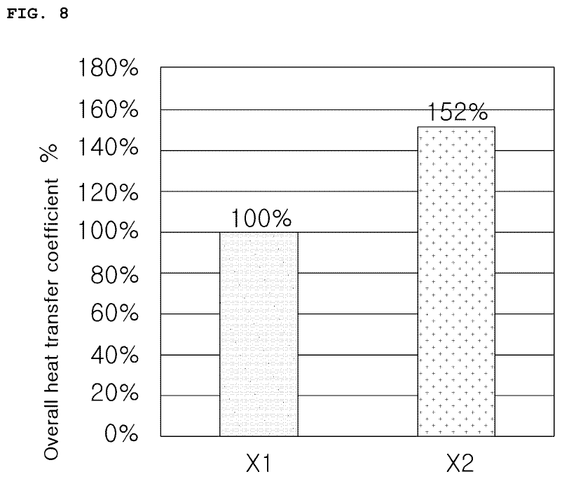

Referring to FIG. 8, the overall heat transfer coefficient according to the embodiments of the present disclosure will be described.

According to the experimental result graph, the overall heat transfer coefficient (hereinafter, referred to as “heat transfer coefficient”) in X2 may increase more than the heat transfer coefficient in X1. For example, the heat transfer coefficient in X2 may increase by about 1.5 times more than the heat transfer coefficient in X1. That is, the heat transfer coefficient may increase as the number of plurality of protrusions 22 increases. In addition, the heat transfer coefficient may increase as the size of the plurality of protrusions 22 decreases. In addition, the heat transfer coefficient may increase as the ratio of the width of the protrusions 22 to the thickness of the heat pipe 20 decreases.

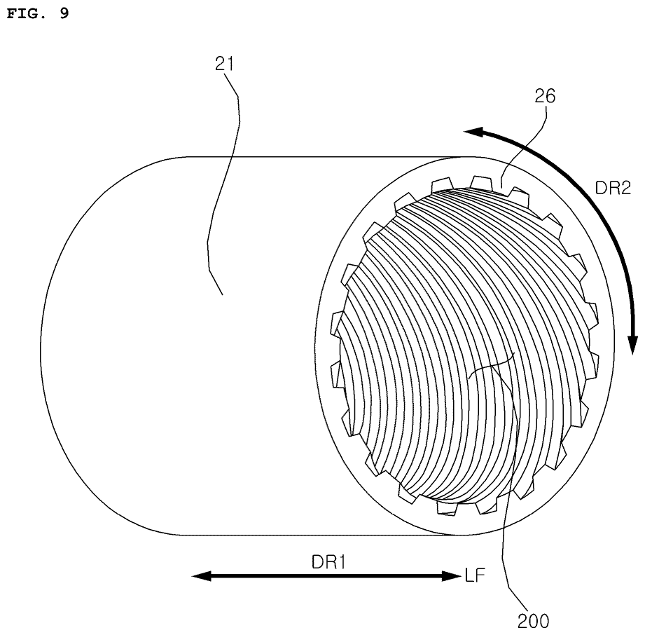

Referring to FIG. 9, the inner shape of the heat pipe 20 is described.

### <A Plurality of Ribs 26>

The heat pipe 20 may include a rib 26 protruding on the inner surface. The rib 26 may protrude from the inner surface of the heat pipe 20 toward the central axis of the heat pipe 20. For example, the rib 26 may protrude in a direction opposite to the radial direction from the inner surface of the base pipe 21.

The rib 26 may be elongated. The rib 26 may be elongated in a spiral shape along the longitudinal direction DR1 of the heat pipe 20. The rib 26 may rotate in the peripheral direction DR2 of the heat pipe 20 and may be elongated in the longitudinal direction DR1. For example, the rib 26 may be elongated in the longitudinal direction DR1 of the heat pipe 20 and may be elongated in a spiral shape along the inner surface of the base pipe 21.

The rib 26 may include a plurality of ribs 26 that are elongated in the longitudinal direction DR1 along the inner surface of the heat pipe 20. The plurality of ribs 26 may be spaced apart from each other in the peripheral direction DR2 of the heat pipe 20. The plurality of ribs 26 may protrude from the inner surface of the heat pipe 20 toward the center of the heat pipe 20 and may be arranged on the inner surface along the peripheral direction DR2 of the heat pipe 20. The plurality of ribs 26 arranged on the inner surface of the heat pipe 20 in the peripheral direction DR2 may extend in a spiral shape along the longitudinal direction DR1 of the heat pipe 20. For example, the heat pipe 20 may include seven to thirteen ribs 26 that are spaced apart from each other in the peripheral direction DR2 along the inner surface and elongated in the longitudinal direction DR1.

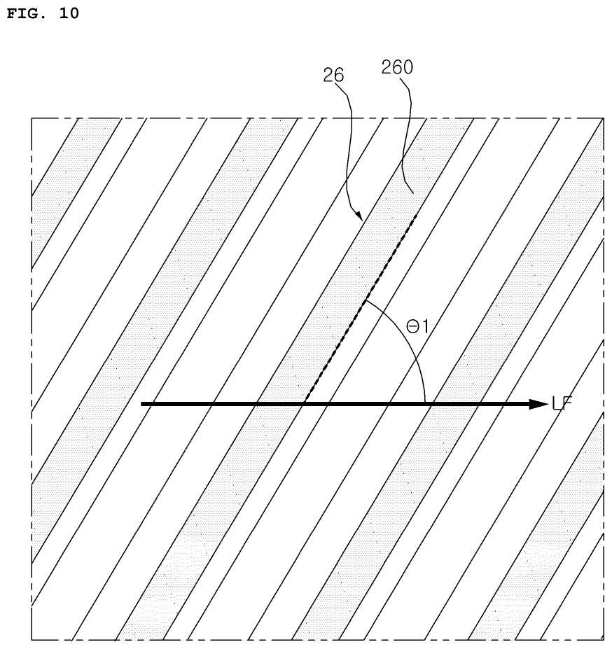

Referring to FIG. 10, the angle at which a plurality of ribs 26 are formed is described.

### <Angle of the Plurality of Ribs 26>

The plurality of ribs 26 may extend diagonally on the inner surface of the heat pipe 20. The plurality of ribs 26 extending diagonally may be spaced apart from each other in the longitudinal direction DR1 of the heat pipe 20. The rib 26 extending helically along the inner surface of the heat pipe 20 may form an angle with the longitudinal direction DR1 of the heat pipe 20. The angle at which the plurality of ribs 26 extend may be oblique to the longitudinal direction DR1 of the heat pipe 20. The angle at which the plurality of ribs 26 extend may be oblique to the flow direction LF of the liquid. For example, the plurality of ribs 26 may form a first angle (theta 1) with respect to the flow direction LF of the liquid. For example, the plurality of ribs 26 may form a first angle (theta 1) with respect to the longitudinal direction DR1 of the heat pipe 20. For example, the first angle (theta 1) may be in the range of 35 degrees to 50 degrees.

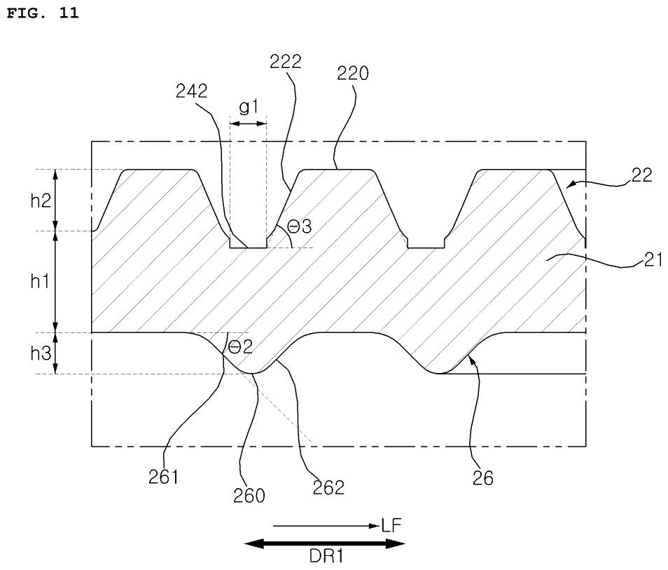

Referring to FIG. 11, the structure of the longitudinal section of the heat pipe 20 is described.

### <Shape of Rib 26>

The width of the rib 26 may decrease as it goes in the protruding direction. The width of the rib 26 may decrease as it gets closer to the center of the heat pipe 20. The width of the rib 26 may extend in the longitudinal direction DR1 of the heat pipe 20. The width of the rib 26 may extend in the flow direction LF of the liquid. For example, the width of the rib 26 formed in the longitudinal direction DR1 of the heat pipe 20 may decrease as it goes in the protruding direction.

### <Slope>

The rib 26 may include a first inclined surface 261 protruding from the heat pipe 20. The first inclined surface 261 may be one surface of the rib 26 protruding from the inner surface of the heat pipe 20. The first inclined surface 261 may protrude from the inner surface of the heat pipe 20. The first inclined surface 261 may extend obliquely in the opposite direction to the flow direction LF of the liquid from the protruding surface 260. The first inclined surface 261 may extend obliquely with respect to the flow direction LF of the liquid. The first inclined surface 261 may form an angle with the longitudinal direction DR1 of the heat pipe 20. The first inclined surface 261 may form an angle with the flow direction LF of the liquid. For example, the first inclined surface 261 may form a second angle (theta 2) with respect to the longitudinal direction DR1 of the heat pipe 20.

The rib 26 may include a second inclined surface 262 protruding from the heat pipe 20. The second inclined surface 262 may be the other surface of the rib 26 protruding from the inner surface of the heat pipe 20. The second inclined surface 262 may protrude from the inner surface of the heat pipe 20. The second inclined surface 262 may extend obliquely from the protruding surface 260 in the flow direction LF of the liquid. The second inclined surface 262 may extend from the protruding surface 260 toward the inner surface of the heat pipe 20. The second inclined surface 262 may form an angle with the longitudinal direction DR1 of the heat pipe 20. The second inclined surface 262 may form an angle with the flow direction LF of the liquid. The angle formed by the second inclined surface 262 with the longitudinal direction DR1 of the heat pipe 20 may correspond to the angle formed by the first inclined surface 261 with the longitudinal direction DR1 of the heat pipe 20.

### <Surface 260>

The rib 26 may include a surface 260 connecting the first inclined surface 261 and the second inclined surface 262. The surface 260 may connect the first inclined surface 261 and the second inclined surface 262 in a curved manner. The surface 260 may be convex toward the center of the heat pipe 20.

The length of the surface 260 may be shorter than the length of the first inclined surface 261 and/or the second inclined surface 262. The extended length of the surface 260 may be shorter than the extended length of the first inclined surface 261. The extended length of the surface 260 may be shorter than the extended length of the second inclined surface 262. For example, the length of the surface 260 extended in the longitudinal direction DR1 of the heat pipe 20 may be shorter than the length of the first inclined surface 261 and/or the length of the second inclined surface 262 extended in the longitudinal direction DR1 of the heat pipe 20.

### <Relationship Between the Height of the Rib 26 and the Thickness of the Pipe>

The rib 26 may protrude from the inner surface of the heat pipe 20. The height at which the rib 26 protrudes from the heat pipe 20 may be in the range of 0.1 mm to 0.3 mm. For example, the height at which the rib 26 protrudes from the inner surface of the heat pipe 20 may be in the range of 0.15 mm to 0.3 mm.

### <Relationship Between the Rib 26 and the Protrusion-Location, Height>

The rib 26 may be located between a plurality of protrusions 22. The plurality of protrusions 22 may be arranged to be spaced apart from each other in the longitudinal direction DR1 of the heat pipe 20, and the plurality of ribs 26 may be located at a location corresponding to the separated distance between the plurality of protrusions 22 based on the longitudinal direction DR1 of the heat pipe 20.

The height at which the plurality of protrusions 22 protrude from the heat pipe 20 may be higher than the height at which the plurality of ribs 26 protrude from the heat pipe 20. The plurality of protrusions 22 may protrude in a radial direction from the heat pipe 20, and the plurality of ribs 26 may protrude inwardly from the heat pipe 20. That is, the plurality of protrusions 22 and the plurality of ribs 26 may protrude in opposite directions from the heat pipe 20.

### <Inclined Surface 261, 262 of Rib 26 and Inclined Surface 222 of Protrusion>

The angle at which the inclined surface 222 of the plurality of protrusions 22 are inclined with respect to the longitudinal direction DR1 of the heat pipe 20 may be larger than the angle at which the inclined surface 261, 262 of the rib 26 are inclined with respect to the longitudinal direction DR1 of the heat pipe 20. For example, the second inclined surface 222 of the protrusion 22 formed on the outer surface of the heat pipe 20 may form a third angle (theta 3) with respect to the longitudinal direction DR1 of the heat pipe 20. For example, the first inclined surface 261 of the rib 26 formed on the inner surface of the heat pipe 20 may form a second angle (theta 2) with respect to the longitudinal direction DR1 of the heat pipe 20. The third angle (theta 3) formed by the first inclined surface 261 of the protrusion 22 with respect to the longitudinal direction DR1 of the heat pipe 20 may be larger than the second angle (theta 2) formed by the first inclined surface 261 of the rib 26.

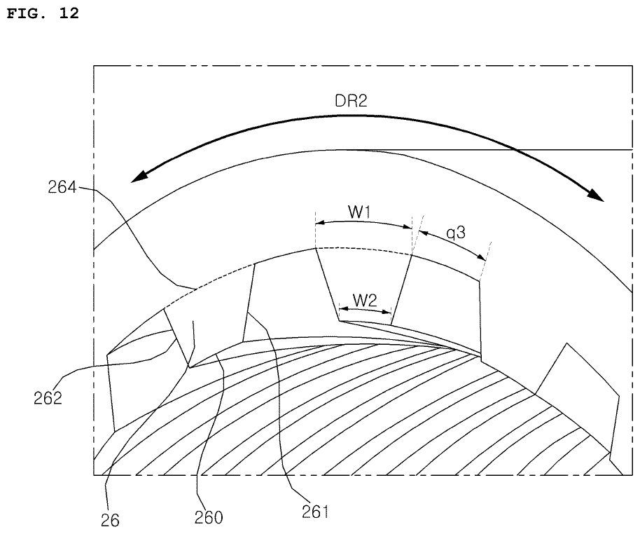

Referring to FIG. 12, the structure of the cross-section of the heat pipe 20 will be described.

### <Cross-Sectional Shape of Rib 26>

The width of the rib 26 may decrease as it goes in the protruding direction. The rib 26 on the cross-section of the heat pipe 20 may have a trapezoidal cross-section. For example, the width W of the rib 26 formed in the peripheral direction DR2 of the heat pipe 20 may decrease as it goes in the protruding direction.

### <Connection Surface 264>

The rib 26 may include a connection surface 264 connected to the heat pipe 20. The connection surface 264 may be connected to the inner surface of the heat pipe 20. The surface 260 may be spaced apart from the connection surface 264. The surface 260 may be spaced apart from the connection surface 264 toward the center of the heat pipe 20. The surface 260 and the connection surface 264 may be spaced apart from each other in the radial direction of the heat pipe 20. The inclined surface 261, 262 may connect the surface 260 and the connection surface 264. The first inclined surface 261 and the second inclined surface 262 may connect the surface 260 and the connection surface 264 at an angle. The connection surface 264 of the rib 26 may be one end of the rib 26 closest to the base pipe 21, and the surface 260 of the rib 26 may be the other end of the rib 26 furthest from the base pipe 21.

### <Length Ratio of Rib 26>

The width of the connection surface 264 may be larger than the width of the surface 260. The width of the connection surface 264 may extend in the peripheral direction DR2 of the heat pipe 20. The width of the surface 260 may extend in the peripheral direction DR2 of the heat pipe 20. For example, the width W1 of the connection surface 264 formed in the peripheral direction DR2 of the heat pipe 20 may be larger than the width W2 of the surface 260 formed in the peripheral direction DR2 of the heat pipe 20. The width of the connection surface 264 may be 1.5 times or more the width of the surface 260. For example, the width of the connection surface 264 may be in the range of 2.0 to 2.5 times the width of the surface 260.

Referring to FIGS. 1 to 12, an absorption type chiller according to an aspect of the present disclosure includes: an evaporator which evaporates refrigerant; an absorber which generates an absorption liquid by mixing the refrigerant evaporated in the evaporator with an absorbent; a regenerator which heats the absorption liquid supplied from the absorber; a condenser to which refrigerant generated in the regenerator is supplied; and a heat pipe which is arranged in at least one of the evaporator and the absorber, and elongated.

According to another aspect of the present disclosure, the heat pipe includes a plurality of protrusions which protrude from a surface of the heat pipe and are arranged in a longitudinal direction and a peripheral direction of the heat pipe.

According to another aspect of the present disclosure, a distance between the plurality of protrusions arranged in the peripheral direction of the heat pipe is smaller than a distance between the plurality of protrusions arranged in the longitudinal direction of the heat pipe.

According to another aspect of the present disclosure, the heat pipe includes a first flow path which is formed between a plurality of protrusions spaced apart from each other in the longitudinal direction of the heat pipe, and extended in the peripheral direction of the heat pipe.

According to another aspect of the present disclosure, the heat pipe includes a second flow path which is formed between the plurality of protrusions arranged in the peripheral direction of the heat pipe, and extended in the longitudinal direction of the heat pipe.

According to another aspect of the present disclosure, a width of the first flow path formed in the longitudinal direction of the heat pipe is larger than a width of the second flow path formed in the peripheral direction of the heat pipe.

According to another aspect of the present disclosure, the first flow path extends in a flow direction of liquid flowing along the surface of the heat pipe.

According to another aspect of the present disclosure, the plurality of protrusions adjacent in the peripheral direction of the heat pipe are directly connected to each other.

According to another aspect of the present disclosure, the heat pipe includes a base pipe which has a surface on which the plurality of protrusions are formed and has a fluid flowing therein.

According to another aspect of the present disclosure, the plurality of protrusions include a first inclined surface which extends in an inclined direction in the peripheral direction of the heat pipe from the protruding surface toward the base pipe.

According to another aspect of the present disclosure, the heat pipe includes a slit formed between the first inclined surfaces of the plurality of adjacent protrusions.

According to another aspect of the present disclosure, the plurality of protrusions include a second inclined surface extending obliquely from the surface toward the first flow path.

According to another aspect of the present disclosure, a distance between the first inclined surfaces formed in the peripheral direction of the heat pipe is shorter than a distance between the second inclined surfaces formed in the longitudinal direction of the heat pipe.

According to another aspect of the present disclosure, a thickness of the heat pipe with respect to a width of a plurality of protrusions formed in the peripheral direction of the heat pipe is within a range of 0.9 to 1.5 times.

According to another aspect of the present disclosure, the distance between the plurality of protrusions arranged in the longitudinal direction of the heat pipe is smaller than a length of the plurality of protrusions extended in the longitudinal direction of the heat pipe.

According to another aspect of the present disclosure, a length of the plurality of protrusions extended in the longitudinal direction of the heat pipe is larger than a width of the plurality of protrusions extended in the peripheral direction of the heat pipe.

According to another aspect of the present disclosure, a height of the plurality of protrusions protruding from the surface of the heat pipe is larger than the distance between the plurality of protrusions arranged in the peripheral direction of the heat pipe.

According to another aspect of the present disclosure, a height of the plurality of protrusions protruding from the surface of the heat pipe is larger than a width of the plurality of protrusions formed in the peripheral direction of the heat pipe.

According to another aspect of the present disclosure, the heat pipe is arranged in both the evaporator and the absorber.

According to at least one of the embodiments of the present disclosure, the heat pipe includes a plurality of protrusions protruding from the surface, so that the heat transfer area of the heat pipe may be increased. Through this, the heat transfer performance of the heat pipe may be improved.

According to at least one of the embodiments of the present disclosure, the gap between the plurality of protrusions arranged in the peripheral direction of the heat pipe may be formed smaller than the gap between the plurality of protrusions arranged in the longitudinal direction of the heat pipe, so that the flowability in the peripheral direction of the heat pipe may be improved.

According to at least one of the embodiments of the present disclosure, the width of the first flow path formed in the peripheral direction of the heat pipe may be formed larger than the width of the second flow path formed in the longitudinal direction of the heat pipe, so that the drainage property of the heat pipe may be improved. Through this, the phenomenon of the absorbent, which flows along the outer surface of the heat pipe, that is stagnated may be reduced.

According to at least one of the embodiments of the present disclosure, a plurality of protrusions arranged in the peripheral direction of the heat pipe are directly connected to each other, thereby minimizing the groove area formed on the outer surface of the heat pipe. Through this, the film thickness formed on the outer surface of the heat pipe may be uniformized. In addition, the film thickness may be made thin.

According to at least one of the embodiments of the present disclosure, the plurality of protrusions include a first inclined surface extending obliquely in the peripheral direction of the heat pipe, thereby further improving the flowability in the peripheral direction of the heat pipe.

According to at least one of the embodiments of the present disclosure, the heat pipe includes a slit formed between the first inclined surfaces, thereby ensuring the spreadability in the longitudinal direction of the heat pipe.

According to at least one of the embodiments of the present disclosure, the plurality of protrusions include a second inclined surface extending obliquely in the longitudinal direction of the heat pipe, thereby improving the spreadability in the longitudinal direction of the heat pipe.

According to at least one of the embodiments of the present disclosure, the thickness of the heat pipe with respect to the width of the plurality of protrusions formed in the peripheral direction of the heat pipe is within a range of 0.9 to 1.5 times, so that the heat transfer area of the heat pipe may be increased. In addition, the thickness of the film formed on the outer surface of the heat pipe may be made thin. Through this, the heat transfer performance of the heat pipe may be improved.

According to at least one of the embodiments of the present disclosure, the heat pipe may be applied to both the evaporator and the absorber, so that the shape of the heat pipe may be standardized, thereby reducing the manufacturing cost. In addition, an absorption type chiller having an improved maintainability may be provided.

The effects of the present disclosure are not limited to the effects mentioned above, and other effects not mentioned will be clearly understood by those skilled in the art from the description of the claims.

Certain embodiments or other embodiments of the disclosure described above are not mutually exclusive or distinct from each other. Any or all elements of the embodiments of the disclosure described above may be combined with another or combined with each other in configuration or function.

For example, a configuration “A” described in one embodiment of the disclosure and the drawings and a configuration “B” described in another embodiment of the disclosure and the drawings may be combined with each other. Namely, although the combination between the configurations is not directly described, the combination is possible except in the case where it is described that the combination is impossible.

Although embodiments have been described with reference to a number of illustrative embodiments thereof, it should be understood that numerous other modifications and embodiments may be devised by those skilled in the art that will fall within the scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. An absorption chiller comprising:
an evaporator configured to carry and evaporate refrigerant therein;
an absorber configured to generate an absorption liquid by mixing the refrigerant from the evaporator with an absorbent;
a regenerator configured to heat the absorption liquid supplied from the absorber;
a condenser configured to receive the refrigerant from the regenerator; and
a heat pipe that is arranged in at least one of the evaporator or the absorber and extends in a longitudinal direction, the heat pipe comprising a plurality of protrusions that protrude from a surface of the heat pipe and are arranged in the longitudinal direction and a peripheral direction of the heat pipe,
wherein a distance between two adjacent protrusions of the plurality of protrusions in the peripheral direction is less than a distance between two adjacent protrusions of the plurality of protrusions in the longitudinal direction.

2. The absorption chiller of claim 1, wherein the heat pipe defines:
a first flow path between columns of the plurality of protrusions that are spaced apart from each other in the longitudinal direction, the first flow path extending in the peripheral direction; and
a second flow path between rows of the plurality of protrusions that are arranged in the peripheral direction, the second flow path extending in the longitudinal direction.

3. The absorption chiller of claim 2, wherein a width of the first flow path in the longitudinal direction is greater than a width of the second flow path in the peripheral direction.

4. The absorption chiller of claim 2, wherein the first flow path extends in a flow direction of fluid along the surface of the heat pipe.

5. The absorption chiller of claim 2, wherein the plurality of protrusions in each column of the plurality of protrusions are directly connected to each other in the peripheral direction.

6. The absorption chiller of claim 5, wherein the heat pipe further comprises a base pipe that defines the surface of the heat pipe from which the plurality of protrusions protrude, the base pipe being configured to carry a fluid therein,
wherein each of the plurality of protrusions comprises:
a protruded surface that protrudes from the base pipe, and
a first inclined surface that connects one end of the protruded surface to the base pipe and is inclined with respect to a radial direction of the base pipe.

7. The absorption chiller of claim 6, wherein the heat pipe defines a slit between the first inclined surfaces of the plurality of protrusions.

8. The absorption chiller of claim 6, wherein each of the plurality of protrusions further comprises a second inclined surface that extends obliquely from the protruded surface toward the first flow path.

9. The absorption chiller of claim 8, wherein a distance between the first inclined surfaces in the peripheral direction is less than a distance between the second inclined surfaces in the longitudinal direction.

10. The absorption chiller of claim 1, wherein a ratio of a thickness of the heat pipe with respect to a width of one of the plurality of protrusions in the peripheral direction is in a range of 0.9 to 1.5.

11. The absorption chiller of claim 1, wherein the distance between the two adjacent protrusions in the longitudinal direction is less than a length of one of the plurality of protrusions in the longitudinal direction.

12. The absorption chiller of claim 1, wherein a length of one of the plurality of protrusions in the longitudinal direction is greater than a width of the one of the plurality of protrusions in the peripheral direction.

13. The absorption chiller of claim 1, wherein a height of one of the plurality of protrusions from the surface of the heat pipe is greater than the distance between the two adjacent protrusions in the peripheral direction.

14. The absorption chiller of claim 1, wherein a height of one of the plurality of protrusions from the surface of the heat pipe is greater than a width of the one of the plurality of protrusions in the peripheral direction.

15. The absorption chiller of claim 1, wherein the heat pipe is arranged in both the evaporator and the absorber.

16. An absorption chiller comprising:
an evaporator configured to carry and evaporate refrigerant therein;
an absorber configured to generate an absorption liquid by mixing the refrigerant from the evaporator with an absorbent;
a regenerator configured to heat the absorption liquid supplied from the absorber;
a condenser configured to receive the refrigerant generated from the regenerator; and
a heat pipe that is arranged in at least one of the evaporator or the absorber, the heat pipe comprising:
a base pipe that extends in a first direction and is configured to carry a fluid therein,
a plurality of protrusions that protrude from a surface of the base pipe and are arranged on the surface of the base pipe in the first direction and a second direction orthogonal to the first direction,
wherein a distance between two adjacent protrusions of the plurality of protrusions in the second direction is less than a distance between two adjacent protrusions of the plurality of protrusions in the first direction.

17. The absorption chiller of claim 16, wherein the heat pipe defines:
a first flow path between columns of the plurality of protrusions that are spaced apart from each other in the first direction, the first flow path extending in the second direction; and
a second flow path between rows of the plurality of protrusions that are arranged in the second direction, the second flow path extending in the first direction.

18. The absorption chiller of claim 17, wherein a width of the first flow path in the first direction is greater than a width of the second flow path in the second direction.

19. The absorption chiller of claim 17, wherein the first flow path extends in a flow direction of the fluid along the surface of the heat pipe.

20. The absorption chiller of claim 17, wherein the plurality of protrusions in each column of the plurality of protrusions are directly connected to each other in the second direction.
